(19) United States
(12) Patent Application Publication
(10) Pub. No.: US 2008/0162764 A1
(43) Pub. Date: Jul. 3, 2008

(54) PROCESSING METHOD AND PROCESSING DEVICE FOR A HARDWARE INTERRUPT

(75) Inventor: Liang Tang, Beijing (CN)

Correspondence Address: DICKSTEIN SHAPIRO LLP, 1177 AVENUE OF THE AMERICAS (6TH AVENUE), NEW YORK, NY, 10036-2714, US

(73) Assignees: Legend Holdings Ltd., Beijing (CN); Lenovo (Beijing) Limited, Beijing (CN)

(21) Appl. No.: 11/966,634

(22) Filed: Dec. 28, 2007

(30) Foreign Application Priority Data
Dec. 28, 2006 (CN) 200610169779.5

(51) Int. Cl. G06F 13/24

(52) U.S. Cl. 710/267

(57) ABSTRACT

The present invention discloses a processing device and a processing method for a hardware interrupt, for processing the sharing interrupt. The processing method for the hardware interrupt comprises steps of: after receiving a hardware interrupt, determining whether the hardware interrupt is a sharing interrupt, and if not, sending the interrupt to a corresponding interrupt processing procedure, otherwise continuing; obtaining a sharing apparatus identifier of the hardware interrupt; for the device corresponding to each obtained sharing apparatus identifier, determining whether it has generated an interrupt according to the interrupt status in a status register of it's PCI configuration space, respectively, and if so, sending the interrupt to the corresponding interrupt processing procedure of the device, otherwise not sending the interrupt to he corresponding interrupt processing procedure. By way of the method of the present invention, the problem in which the interrupt processing doesn't match with the hardware device generating the hardware interrupt may be avoided.

### BACKGROUND OF THE INVENTION

1. Field of Invention

The present invention relates to an interrupt processing, more practically relates to a processing method and a processing device for a hardware interrupt.

2. Description of Prior Art

In the present computer system, the system often provides the upper level application and user's operating system with a device service by an interrupt request function, such as request_iqr ( ). The parameters of the interrupt request function in general include an interrupt number and an interrupt procedure. Simultaneously, it supports that a plural of apparatuses share one interrupt number in the prior art, so in an interrupt vector table of the system, there may be a plural of corresponding interrupt processing procedures with one interrupt number. When one of the devices sharing the same interrupt number is making an interrupt, the system often calls all the interrupt procedures of the interrupt number in the interrupt vector table, thereby resulting in problems such as the instability of the system due to the mismatch between the interrupt procedure and the apparatus generating the interrupt.

In the present virtual machine technique, it has been realized that the customer's operating system directly requests the hardware's service by the virtual machine's monitor (VMM). For example, it discloses a virtual machine system in the patent application specification of a Chinese patent application No. 200610128624.7, filed on Aug. 29, 2006, by the present applicator, one interrupt converting module is maintained in the virtual machine monitor of the system, and the interrupt converting module is used to convert a hardware interrupt of the hardware apparatus into a virtual interrupt request of the corresponding customer's operating system according to the interrupt converting table, and informs the virtual interrupt controller. Wherein, the interrupt converting table includes the information of the hardware interrupt, the hardware apparatus, the customer's operating system, and the virtual interrupt request, etc. Of course there are other particular implementing methods by which the customer's operating system requests the hardware apparatus' service. But if a plural of hardware apparatus share one interrupt number and each hardware apparatus is requested service by various customer's operating systems, then when one hardware apparatus makes a hardware interrupt, the hardware interrupt will be sent to a plural of customer's operating systems, thereby resulting in that one system receives extra interrupts. Since the processing of an interrupt doesn't match up with the hardware apparatus really generating the hardware interrupt, leading to that the system and the apparatus work abnormally, even the system crashed.

### SUMMARY OF THE INVENTION

The technical problem solved by the present invention is to provide a processing method for the hardware interrupt, by which it ensures that the interrupt generated by the hardware apparatus is sent to the correct interrupt processing procedure.

A processing method for a hardware interrupt provided by the present invention comprises steps of:

A) determining whether the hardware interrupt is a sharing interrupt after receiving a hardware interrupt; if not, sending the interrupt to the corresponding interrupt processing procedure; otherwise continuing to the step B);
B) obtaining the sharing apparatus' identifier of the hardware interrupt;
C) determining whether it has generated an interrupt for each obtained apparatus sharing the apparatus' identifier according to the interrupt sate in the PCI configuring spaces thereof, if so, sending the interrupt to the corresponding interrupt processing procedure of the apparatus, otherwise not sending the interrupt to the corresponding processing procedure of the apparatus.

Further, before the step A), said method comprises step of obtaining the information corresponding to the hardware apparatus' identifier and the interrupt number in the system by the system command or by a system power management interface.

Or the information corresponding to the hardware apparatus' identifier and the interrupt number is stored in the system.

In the step A), said method determines whether the hardware interrupt is a sharing interrupt according to the information corresponding to the hardware apparatus' identifier and the interrupt number in the system; and

in the step B), said method obtains the sharing apparatus' identifier in the hardware interrupt according to the information corresponding to the hardware apparatus' identifier and the interrupt number.

In the processing method for the hardware interrupt provided by the present invention, when a hardware interrupt is received, said method determines whether said interrupt is a sharing interrupt; if so, it is determined whether the sharing apparatus of the interrupt has generated an interrupt, and when the apparatus has generated the interrupt the interrupt is sent to the interrupt processing procedure requesting the apparatus' service, thereby ensuring that the interrupt generated by the hardware apparatus is sent to the correct interrupt processing procedure, and avoiding the problems caused by the mismatch between the interrupt processing and the hardware apparatus generating the hardware interrupt.

Another technical problem solved by the present invention is to provide a processing device for a hardware interrupt, by said device it can ensure that makes a correct interrupt processing to the interrupt generated by the hardware apparatus.

A processing device for a hardware interrupt provided by the present invention comprises modules of:

sharing interrupt determining module, for determining whether the hardware interrupt is a sharing interrupt when receiving a hardware interrupt, and if so, the interrupt is sent to the sharing apparatus obtaining module; sharing apparatus obtaining module, for receiving the interrupt sent by the interrupt sharing module and for obtaining the sharing apparatus' identifier of the hardware interrupt, and sending the interrupt and sharing apparatus' identifier to the apparatus' interrupt generating determining module;
apparatus' interrupt generating determining module, for receiving the interrupt and the sharing apparatus' identifier sent by the sharing apparatus obtaining module, determining whether it has generated an interrupt for each corresponding apparatus sharing the apparatus' identifier according to the interrupt sate in the PCI configuring spaces thereof, if so, calling the corresponding interrupt processing procedure to process the interrupt, and if not, it does not call the corresponding interrupt processing procedure.

Further, the interrupt processing device provided by the present invention further comprises interrupt information storing module, for storing the information corresponding to the interrupt number and the hardware apparatus identifier; the interrupt sharing determining module determines whether the interrupt number is a sharing interrupt according to the corresponding information, and the sharing apparatus obtaining module obtains the sharing apparatus' identifier of the interrupt according to the corresponding information.

The interrupt processing device provided by the present invention further comprises interrupt's information obtaining module, for obtaining the corresponding information of the system's interrupt number and the hardware apparatus' identifier, and sending the corresponding information to the interrupt sharing determining module and the sharing apparatus obtaining module. The interrupt sharing determining module determines whether the interrupt is a sharing interrupt, and the sharing apparatus obtaining module obtains the sharing apparatus' identifier of the interrupt according to the received corresponding information.

In the processing device for the hardware interrupt provided by the present invention, when a hardware interrupt is received, it is determined whether said interrupt is a sharing interrupt by the sharing interrupt determining module, if so, the sharing apparatus' identifier of the interrupt is obtained by the sharing apparatus obtaining module, and further it is determined whether the sharing apparatus of the interrupt has generated an interrupt by the apparatus' interrupt generating module, and for the sharing apparatus having generated the interrupt the interrupt the interrupt is sent to the interrupt processing procedure requesting the apparatus' service, whereas for the sharing apparatus having not generated the interrupt the interrupt is not sent to the interrupt processing procedure requesting the apparatus' service. By the processing device for the hardware interrupt mentioned above, it can make a correct interrupt processing for the interrupt generated by the hardware apparatus, avoiding the problems caused by the mismatch between the interrupt processing and the hardware apparatus generating the hardware interrupt.

### BRIEF DESCRIPTION OF THE DRAWINGS

FIG. 1 is a general flowchart for illustrating the processing method for a hardware interrupt of the present invention;

FIG. 2 is a configuring view for illustrating the processing apparatus for a hardware interrupt according to the present invention; and

FIG. 3 is a configuring view of the processing device for a hardware interrupt in the virtual machine system of the present invention.

### DETAILED DESCRIPTION OF PREFERRED EMBODIMENTS

In the following description, the hardware apparatus sharing one interrupt is called as the sharing apparatus of said interrupt, and said interrupt is called as the sharing interrupt. The hardware apparatus' identifier is used to represent the corresponding hardware apparatus, and the interrupt number is used to represent the corresponding hardware interrupt.

The input parameters of the interrupt request function include the corresponding apparatus' name and the apparatus' identifier other than the interrupt number and the interrupt processing procedure.

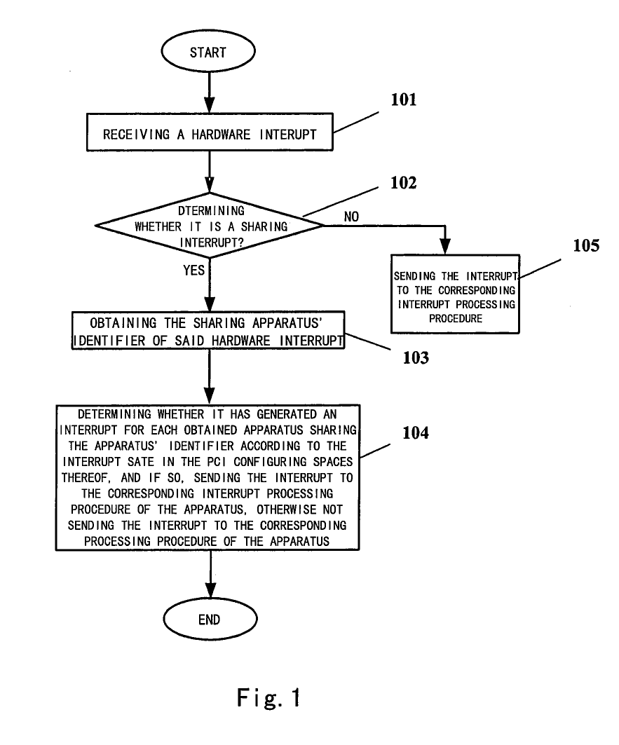

As shown in FIG. 1, a processing method for a hardware interrupt provided by the present invention, applied to the computer system with PCI bus configure, comprises steps of:

At step 101, the hardware interrupt is obtained by the interrupt controller. When the hardware makes an interrupt, the system kernel obtains the interrupt number corresponding to said hardware interrupt by the interrupt controller.

At step 102, it is determined whether said hardware interrupt is a sharing interrupt. If it is a sharing interrupt, it goes to step 103, otherwise goes to step 105 in which the interrupt is sent to the corresponding interrupt processing procedure.

The system kernel determines whether the hardware interrupt corresponding to the interrupt number is a sharing interrupt or not after obtaining the interrupt number. Once it is implemented by the system command, the information corresponding to the hardware apparatus' identifier and the interrupt number in the system is obtained. And if a plural of hardware apparatuses correspond to said interrupt number, it is determined that the hardware interrupt corresponding to said interrupt number is a sharing interrupt, otherwise it is determined that the hardware interrupt corresponding to said interrupt number is not a sharing interrupt. For example, in the Linux system, the information shown in Table 1 is obtained by calling the system command “cat/proc/interrupts”:

| Interrupt Number | Interrupt Type | Hardware Apparatus' Identifier |
|---|---|---|
| 0 | IO-APIC-edge | Timer |
| 7 | IO-APIC-edge | Parport0 |
| 8 | IO-APIC-edge | Rtc |
| 9 | IO-APIC-level | Acpi |
| 14 | IO-APIC-edge | Libata |
| 15 | IO-APIC-edge | Libata |
| 16 | IO-APIC-level | HDA Intel, ehci_hcd:usb1, |
| | | ehci_hcd:usb2, uhci_hcd:usb3, |
| | | uhci_hcd:usb5 |
| 17 | IO-APIC-level | Uhci_hcd:usb4, uhci_hcd:usb6 |
| 18 | IO-APIC-level | libata, hci_hcd:usb7 |
| 19 | IO-APIC-level | eth0 |

If the interrupt number obtained by the system kernel is 16, it can be known from the information of Table 1 that the hardware apparatus' identifier corresponding to the interrupt number 16 include HAD Intel, ehci_hcd:usb1, ehci_hcd:usb2, uhci_hcd:usb3, uhci_hcd:usb5, that is, there are a plural of hardware apparatus' identifiers that correspond to the interrupt number. So it is determined that the hardware interrupt corresponding to the interrupt number is a sharing interrupt. If the interrupt number obtained by the system kernel is 19, it can be known from the information of Table 1 that the hardware apparatus' identifier corresponding to the interrupt number 19 includes eth0, that is, there is only one hardware apparatus' identifier that corresponds to the interrupt number. So it is determined that the hardware interrupt corresponding to the interrupt number is not a sharing interrupt.

The information on the hardware apparatus' identifier and the interrupt number may be obtained by performing a system command before it is determined whether the hardware interrupt is a sharing interrupt. But because the information corresponding to the hardware apparatus' identifier and the interrupt number after the system's startup commonly may not be changed at discretion, the corresponding information mentioned above may be stored into the system. Thus, when it is necessary to determine whether a hardware interrupt is a sharing interrupt, it can be determined according to the corresponding information stored in the system, and it is not needed to perform a system command whenever to determine, thereby improving the efficiency to determine whether a hardware interrupt is a sharing interrupt.

If the obtained hardware interrupt is not a sharing interrupt, it directly calls the processing procedure of said interrupt, otherwise it continues to step 103.

At step 103, the sharing apparatus' identifier of the hardware interrupt is obtained. It may be known, from the description about the step 102 above, that the information corresponding to the hardware apparatus' identifier and the interrupt number can be obtained by the system command, and the sharing apparatus' identifier of the hardware interrupt can be obtained by the corresponding information.

At step 104, it is determined whether an interrupt is generated for each obtained apparatus sharing the apparatus' identifier or not according to the interrupt sate in the PCI configuring spaces thereof, respectively. If so, the interrupt is sent to the corresponding interrupt processing procedure of the apparatus requesting said apparatus' service, otherwise the interrupt is not sent to the corresponding processing procedure of the apparatus requesting said apparatus' service.

The Interrupt Status (INTS) of the PCI Status Register (PCISTS) in the configuring space of the apparatus is read out for each corresponding obtained apparatus sharing the apparatus' identifier. If the interrupt status shows that the apparatus make an interrupt, the interrupt processing procedure corresponding to the apparatus is called; otherwise the interrupt processing procedure corresponding to the apparatus is not called. The determining of the interrupt state of the sharing apparatus is performed in turn, and it may be performed parallel under the condition allowed by the system processing ability.

The preferable embodiment of the method provided by the present invention is applied to the computer system with PCI/PCIE bus configure. It is normally the PCI apparatuses that share an interrupt, that is to say, the sharing apparatuses normally are PCI apparatuses.

The embodiment of the processing method for a hardware interrupt of the present invention is that the information on the interrupt number and the hardware apparatus' identifier is stored in the system, and after the virtual machine's monitor obtains the interrupt number corresponding to the hardware interrupt, the following steps are performed:

determining whether said hardware interrupt is a sharing interrupt by the stored information corresponding to the interrupt number and the hardware apparatus' identifier; if not, it calls the interrupt processing procedure for the hardware interrupt; otherwise, if so, all the hardware apparatus' identifiers corresponding to the interrupt number are obtained, in which the information corresponding to the hardware interrupt and the hardware apparatus may be obtained by the system command, for example, obtained by the cat command in the Linux system or by the power management interface of the system.

The implementing example of the processing method for the hardware interrupt of the present invention applied to the virtual machine monitor comprises steps of:

firstly, when the hardware apparatus makes an interrupt, the virtual machine's monitor obtains the interrupt number corresponding to the hardware interrupt by the interrupt controller;
then, the virtual machine's monitor determines whether the hardware interrupt is a sharing interrupt; if it is a sharing interrupt it continues to the following steps; otherwise the interrupt is sent to the corresponding customer's operating system; and
next, the sharing apparatus' identifier of the hardware interrupt is obtained by the method at step 103.

Further, it is determined whether an interrupt is generated for the apparatus corresponding to each obtained sharing apparatus' identifier according to the interrupt status in the apparatus' PCI configuring space. If so, the interrupt is sent to the corresponding customer's operating system requesting the apparatus' service; and otherwise, the interrupt is not sent to the corresponding customer's operating system requesting the apparatus' service.

In the processing method for the hardware interrupt provided by the present invention, when a hardware interrupt is received, said method determines whether said interrupt is a sharing interrupt; if so, it is determined whether the sharing apparatus of the interrupt has generated an interrupt, and when the apparatus has generated the interrupt the interrupt is sent to the interrupt processing procedure requesting the apparatus' service, otherwise the interrupt is not sent to the interrupt processing procedure requesting the apparatus' service, thereby ensuring that the interrupt generated by the hardware apparatus is sent to the correct interrupt processing procedure, and avoiding the problems caused by the mismatch between the interrupt processing and the hardware apparatus generating the hardware interrupt.

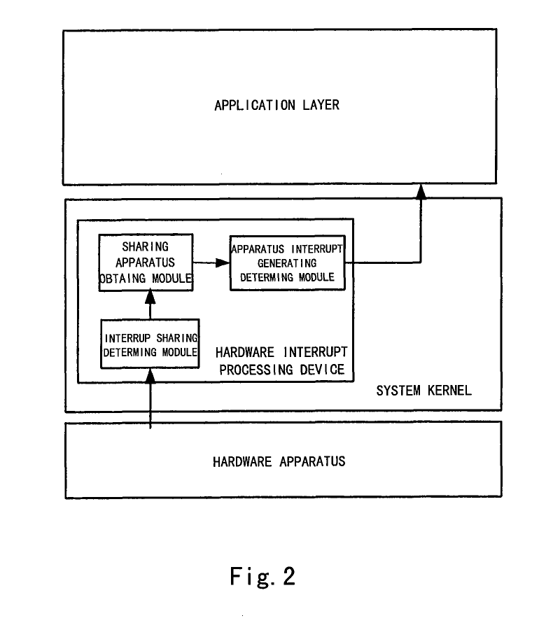

As shown in FIG. 2, a processing device for a hardware interrupt provided by the present invention is applied to a computer system. The interrupt processing device comprises a sharing interrupt determining module, a sharing apparatus obtaining module and an apparatus' interrupt generating determining module. The system kernel sends the received hardware interrupt to the interrupt processing device, and various modules of the device are described as follows.

Sharing interrupt determining module is used for determining whether the hardware interrupt is a sharing interrupt, and if so, the interrupt is sent to the sharing apparatus obtaining module;

For the determination of whether a hardware interrupt is a sharing interrupt, the system command may be called at first to obtain the information corresponding to the interrupt number and the hardware apparatus' identifier. And then it detects whether there are a plural of hardware apparatus' identifiers correspond to the interrupt representing the hardware interrupt. If so, it is a sharing interrupt; otherwise it is not a sharing interrupt. The system command mentioned above is the “cat” command in the Linux system. It may be determined whether a hardware interrupt is a sharing interrupt by the power management interface.

Sharing apparatus obtaining module is used for receiving the interrupt sent by the interrupt sharing module and for obtaining the sharing apparatus' identifier of said interrupt, and sending the interrupt and sharing apparatus' identifier to the apparatus' interrupt generating determining module.

The sharing apparatus of one hardware interrupt may be obtained by the system command provided by the system, such as the “cat” command in the Linux system, or by the power management interface.

Apparatus' interrupt generating determining module is used for receiving the interrupt and the sharing apparatus' identifier sent by the sharing apparatus obtaining module, determining whether it has generated an interrupt for each corresponding apparatus sharing the apparatus' identifier according to the interrupt status read out from the PCI status register of the PCI configuring spaces thereof. If so, the interrupt is sent to the corresponding interrupt processing procedure requesting the apparatus' service; and if not, the interrupt is not sent to the corresponding interrupt processing procedure requesting the apparatus' service.

Further, the interrupt processing device further comprises an interrupt information storing module, for storing the information corresponding to the interrupt number and the hardware apparatus' identifier in the system.

After the system kernel received the system kernel, the sharing interrupt determining module determines whether the hardware interrupt is a sharing interrupt according to the information in the interrupt information storing module, and the sharing apparatus obtaining module obtains all the sharing apparatus' identifier of the hardware interrupt according to the information in the interrupt information storing module.

The interrupt processing apparatus further comprises an interrupt information obtaining module which is used for obtaining the information corresponding to the interrupt number and the hardware apparatus' identifier in the system, and sending the corresponding information to the interrupt sharing determining module and the sharing apparatus obtaining module. The interrupt sharing determining module determines whether the interrupt is a sharing interrupt according to the corresponding received information, and the sharing apparatus obtaining module obtains the sharing apparatus' identifier corresponding to the interrupt according to the corresponding received information.

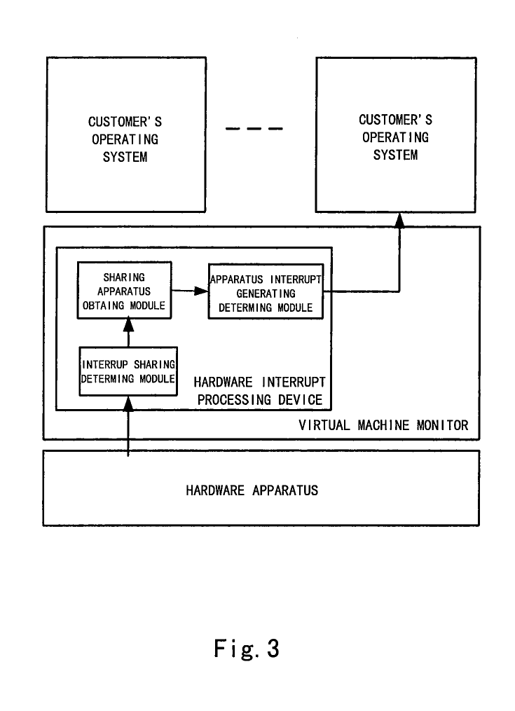

As shown in FIG. 3, it shows an embodiment in the virtual machine system of the interrupt processing device of the present invention, in which the virtual machine corresponds to the system kernel. Sharing interrupt determining module is used to determine whether a hardware interrupt is a sharing interrupt. If not, the interrupt processing procedure for the interrupt is called, and if it is a sharing interrupt, the interrupt is sent to the sharing apparatus obtaining module. The sharing apparatus obtaining module is used to receive the interrupt sent by the interrupt sharing module, obtain the sharing apparatus' identifier of said interrupt, and send the interrupt and sharing apparatus' identifier to the apparatus' interrupt generating determining module. The apparatus' interrupt generating determining module is used to receive the interrupt and the sharing apparatus' identifier sent by the sharing apparatus obtaining module, determine whether it has generated an interrupt for each corresponding apparatus sharing the apparatus' identifier according to the interrupt status read out from the PCI status register of the PCI configuring spaces. If so, a virtual interrupt is sent to the corresponding customer's operating system requesting the apparatus' service; and if not, a virtual interrupt is not sent to the corresponding customer's operating system requesting the apparatus' service.

When receiving a hardware interrupt, the processing device for a hardware interrupt provided by the present invention determines whether said interrupt is a sharing interrupt by the interrupt sharing determining module. If so, the sharing apparatus' identifier of said interrupt is obtained by the sharing apparatus obtaining module, and it is determined by the apparatus interrupt generating determining module whether the sharing apparatus has generated an interrupt. For the sharing apparatus having generated an interrupt the interrupt is sent to the corresponding interrupt processing procedure requesting the apparatus' service, and for the sharing apparatus having not generated an interrupt the interrupt is not sent to the corresponding interrupt processing procedure requesting the apparatus' service, thereby make a correct interrupt processing for the interrupt generated by the hardware apparatus and avoiding the problems caused by the mismatch between the interrupt processing and the hardware apparatus generating the hardware interrupt.

The computer system of the present invention includes devices and systems having computing ability, operating system and periphery hardware, such as a personal computer (PC), server, notebook, palm computer, personal data assistant and the like.

Although the present invention is illustrated with reference to the preferred embodiments thereof, it can be understood by those skilled in the art that various changes, substitutions and alters to the present invention are possible without departing from the spirit and scope of the present invention. Therefore, the present invention is not limited to the above embodiments but only limited by the following claims and the equivalents thereof.

1. A processing method for a hardware interrupt, applied to a computer system under PCI/PCIE bus architecture, comprising steps of:
A) determining whether the hardware interrupt is a sharing interrupt after receiving a hardware interrupt, and if not, sending the interrupt to the corresponding interrupt processing procedure, otherwise continuing to step B);
B) obtaining the sharing apparatus' identifier of the hardware interrupts;
C) determining whether it has generated an interrupt for each obtained apparatus sharing the apparatus' identifier according to the interrupt sate in the PCI configuring spaces thereof, and if so, sending the interrupt to the corresponding interrupt processing procedure of the apparatus, otherwise not sending the interrupt to the corresponding processing procedure of the apparatus.

2. The method according to claim 1, wherein
in the step A), determining whether the hardware interrupt is a sharing interrupt according to the information corresponding to the hardware apparatus' identifier and the interrupt number in the system; and
in the step B), obtaining the sharing apparatus' identifier in the hardware interrupt according to the information corresponding to the hardware apparatus' identifier and the interrupt number.

3. The method according to claim 2, before the step A), further comprising a step of:
obtaining the information corresponding to the hardware apparatus' identifier and the interrupt number in the system by a system command or by a system power management interface.

4. The method according to claim 2, wherein the information corresponding to the hardware apparatus' identifier and the interrupt number is stored in the system.

5. The method according to claim 1, wherein said computer system is a virtual machine system.

6. A processing device for a hardware interrupt, applied to a computer system, comprising:
sharing interrupt determining module, for determining whether the hardware interrupt is a sharing interrupt when receiving a hardware interrupt, and if so, the interrupt is sent to the sharing apparatus obtaining module;
sharing apparatus obtaining module, for receiving the interrupt sent by the interrupt sharing module and for obtaining the sharing apparatus' identifier of the hardware interrupt, and sending the interrupt and sharing apparatus' identifier to the apparatus' interrupt generating determining module;
apparatus' interrupt generating determining module, for receiving the interrupt and the sharing apparatus' identifier sent by the sharing apparatus obtaining module, determining whether it has generated an interrupt for each corresponding apparatus sharing the apparatus' identifier according to the interrupt status in the PCI configuring spaces thereof, if so, calling the corresponding interrupt processing procedure to process the interrupt, and if not, not calling the corresponding interrupt processing procedure.

7. The processing device according to claim 6, further comprising:
interrupt information storing module, for storing the information corresponding to the interrupt number and the hardware apparatus identifier; the interrupt sharing determining module determines whether the interrupt number is a sharing interrupt according to the corresponding information, and the sharing apparatus obtaining module obtains the sharing apparatus' identifier of the interrupt according to the corresponding information.

8. The processing device according to claim 6, further comprising: interrupt's information obtaining module, for obtaining the corresponding information of the system's interrupt number and the hardware apparatus' identifier, and sending the corresponding information to the interrupt sharing determining module and the sharing apparatus obtaining module. The interrupt sharing determining module determines whether the interrupt is a sharing interrupt, and the sharing apparatus obtaining module obtains the sharing apparatus' identifier of the interrupt according to the received corresponding information.

9. The processing device according to claim 5, wherein said computer system is a virtual system.

10. The method according to claim 2, wherein said computer system is a virtual machine system.

11. The method according to claim 3, wherein said computer system is a virtual machine system.

12. The method according to claim 4, wherein said computer system is a virtual machine system.

13. The processing device according to claim 6, wherein said computer system is a virtual system.

14. The processing device according to claim 7, wherein said computer system is a virtual system.

15. The processing device according to claim 8, wherein said computer system is a virtual system.
